(19) United States
(12) Patent Application Publication
(10) Pub. No.: US 2016/0186714 A1
(43) Pub. Date: Jun. 30, 2016

(54) WATER POWERED ELECTRICAL GENERATOR WITH OUTLET AERATION FEATURE FOR MARINE LIFE AND INCLUDING MINIMAL WATER DROP WITH NO HEAD PRESSURE

(71) Applicant: Gerald A. Filipek, Washington, MI (US)

(72) Inventor: Gerald A. Filipek, Washington, MI (US)

(21) Appl. No.: 14/982,743

(22) Filed: Dec. 29, 2015

Related U.S. Application Data
(60) Provisional application No. 62/097,442, filed on Dec. 29, 2014.

(51) Int. Cl. F03B 13/08; H02K 7/18

(52) U.S. Cl. CPC F03B 13/08; H02K 7/1823

(57) ABSTRACT

A water powered generator having a cylindrical shaped body supported in a substantially submerged fashion within a flowing body of water. A bracket extends from the body and is adapted to affix the same to an underwater bed location. A rotatable shaft extends vertically through a central interior of the body and about which are secured a plurality of vanes. An inlet of the body directs an inlet flow of fluid into an outer peripheral location of the body interior. A vertically descended outlet of the body aligns with the central interior and causes the creation of a naturally occurring vortex in the fluid passing within the body, this enhancing the rotational driving of the shaft, to which an electrical generator or other work output linkage can be connected, and prior to the fluid being discharged through the outlet.

### CROSS-REFERENCE TO RELATED APPLICATIONS

This application claims the benefit of U.S. Provisional Application 62/097,442 filed on Dec. 29, 2014, the contents of which are incorporated herein in its entirety.

### FIELD OF THE INVENTION

The present invention relates generally to a fluid powered output assembly, such as in one non-limiting preferred embodiment including a hydroelectric generator. More particularly, the present invention discloses a water powered electrical generator which integrates a swirl chamber construction for magnifying and optimizing a power output associated with slow to moderate flowing bodies of water within which the generator is situated, such as which are often further associated with relatively small vertical drops in elevation existing within the body of water (e.g. rivers, streams, etc.). The construction of the water powered electrical generator is further such that it is largely safe to marine aquatic life and can further include a water outflow oxygenator for further benefitting such marine life including notably fish.

### BACKGROUND OF THE INVENTION

As is known, the prior art is well documented with examples of water powered turbine, generator and other work output assemblies. In each instance, the objective of the assembly is to harness a work input, typically in the form of a flowing body of water, in order to create an initially rotating work output (e.g. a rotating shaft) which can either be tapped through a gear arrangement for a direct work output. Alternatively, an electrical generating component is operatively communicated with the output shaft for producing electricity.

Known examples of water generated assemblies include the undershot impulse jet driven water turbine of Broome, US 2009/0175723, which teaches a low-head impulse jet water turbine for electric power generation at irrigation canal drop structures, navigation dam spillways or other low head watercourses for providing renewable electric power generation. Kinetic energy of a low-pressure jet is employed in a way that enables numerous locations to generate electricity conveniently near points of use, from a renewable source. The equipment is further described as pre-assembled for minimum installation on site and with no existing impoundment and which can be raised clear of flood levels with built-in lifting equipment. The system for raising the equipment is also disclosed as providing clear passage for fish migration.

US 2007/0122279 to Sredzki et al. teaches a turbine device that consists of blades, cables, shaft, and sometimes flotation sections in the Blades for small (from under 1 KW) to large (multi MW) scale Energy Extraction (Potential and Kinetic) from currents, and for converting to mechanical and subsequently electrical energy. A cylindrical structure is provided which is less than 50% submerged into a water flowing current, and is designed to harvest the Energy, made available by a head induced across the blades which restrictively rotate slower than the current during the extraction of energy from the current.

U.S. Pat. No. 4,868,408, to Hesh, teaches a portable water-powered electric generator having a tubular form with opposite open inlet and outlet ends defining a longitudinal flow path for the moving stream water. The tubular form defines a converging Venturi terminating at a throat between the inlet and outlet ends. An electric dynamo, having a sealed housing and external driving propeller means, is supported in the flow path downstream of the throat, with the propeller means at the throat. The inlet end is between 2-5 times larger in area than the Venturi throat, to speed up the water passing through the propeller means. The tubular form and housing together define a diverging Venturi downstream from the throat, decelerating the water with minimal losses before exiting from the open outlet end. The open outlet end is 1.1-1.5 times larger in area than the open inlet end, whereby the slightly faster surrounding stream water blending with the exiting water at the open outlet end may tend to accelerate the exiting water slightly for added efficiencies. A buoyancy chamber, with remotely operated valve and gas pressure means, is on the portable electric generator unit to regulate its overall buoyancy, for adjusting its operative depth of use in the stream.

### SUMMARY OF THE INVENTION

The present invention discloses a water powered generator having a cylindrical shaped body supported in a substantially submerged fashion within a flowing body of water. A bracket extends from the body and is adapted to affix the same to an underwater bed location.

A rotatable shaft extends vertically through a central interior of the body and about which are secured a plurality of vanes. An inlet of the body directs an inlet flow of fluid into an outer peripheral location of the body interior. A vertically descended outlet of the body aligns with the central interior and causes the creation of a naturally occurring vortex in the fluid passing within the body, this enhancing the rotational driving of the shaft, and prior to the fluid being discharged through the outlet.

Other features include an electrical converting component situated atop the body and communicating with an upper projecting end of the rotating shaft. A bottom end of the shaft supports a rotary actuated water aeration component. A debris gate can also be situated at the inlet.

Additional features include a journal support bracket affixed to an underside of an upper chamber defining wall associated with the body, the shaft extending upwardly through the bracket and being supported by bearings contained within the bracket, the shaft progressively extending through an aperture in the upper wall and terminating in contact with the electrical converting component. Yet additional features can include a swing arm integrated into the entry gate of the assembly and which is pivot adjustable, such as via a heavy duty screw mount, relative to a terminating wall location associated with the inlet stream in order to tune a volume of water flow into the generator in order to optimize operation of the same.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a top view in partially cutaway fashion of the hydro powered electric generator according to one non-limiting embodiment of the present inventions; and

FIG. 2 is a partially rotated side view of the generator of FIG. 1, again in cutaway, and illustrating the water inlet and outlet locations in combination with the placement of the generator in a substantially submersed fashion within a body of water at a location of modest vertical drop.

### DETAILED DESCRIPTION OF THE PREFERRED EMBODIMENTS

As previously described, the present inventions disclose a fluid powered output assembly, such as in one non-limiting preferred embodiment including a hydroelectric generator, and which can be utilized in relatively slow moving bodies of water, such as rivers or streams exhibiting modest vertical drops in elevation. The assembly, as will be described below in detail, is particularly suited for use in smaller moving bodies of water such as streams associated with rural locations and for providing a hydro generated electrical output, as well as other mechanical rotary work output options, and such as in order to provide low cost power to a single (residential) location with access to a moderate amount of river flow and little elevation change.

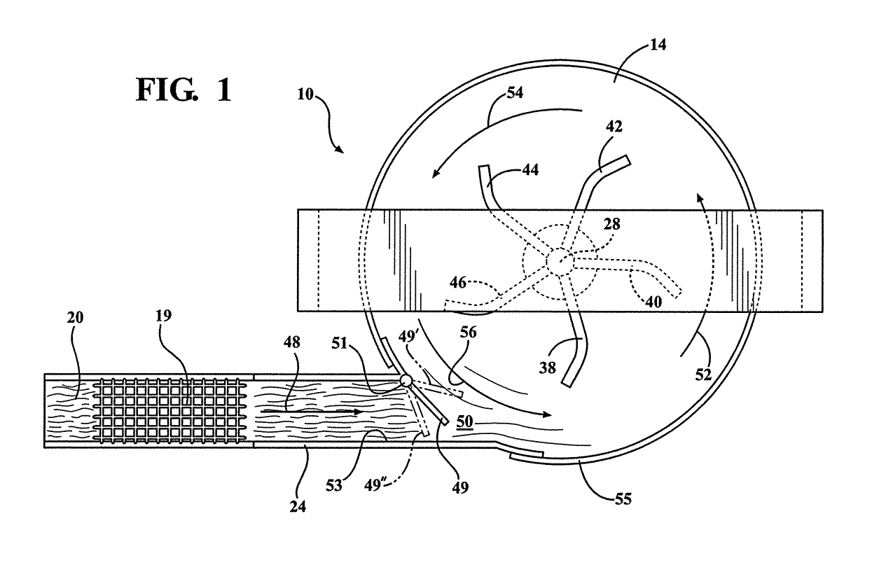

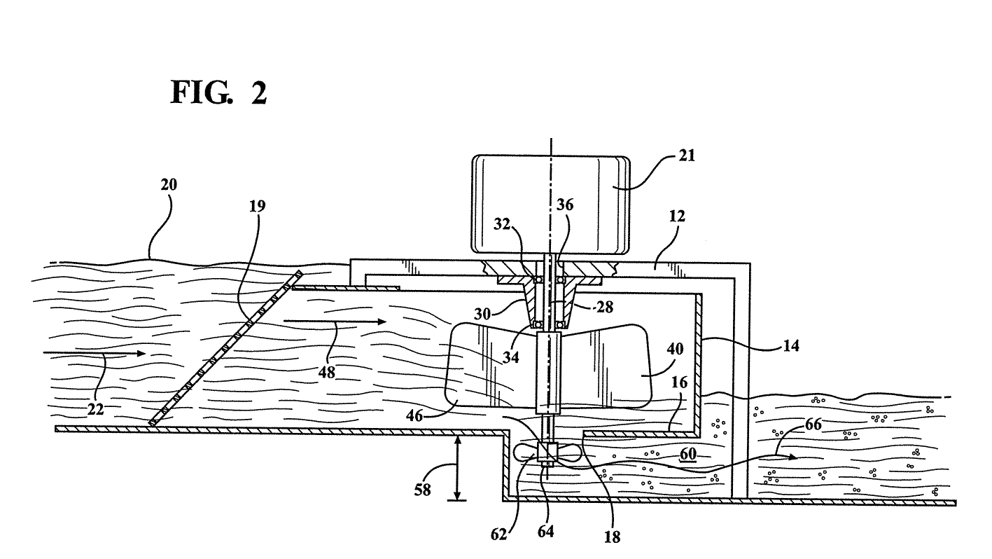

Referring to FIGS. 1-2, corresponding top and partially side rotated views are shown, each in a partially cutaway fashion, of the hydro powered electric generator, generally at 10, according to one non-limiting embodiment of the present inventions. A support structure, referenced at 12 in FIG. 1, is provided in the form of a three dimensional fixed support for the submerged assembly, such as which can be fixedly secured or anchored to an underwater bed.

Without limitation, the support structure can include additional anchors or like restraining structure in order to be firmly affixed to the underwater ground location and so that a main swirl chamber portion, depicted by circular side wall 14 and radial base wall 16 with a central open location (see inner radial edge 18), a debris gate or filter 19 being located in the inlet stream further defined in the body, which is in turn substantially submerged within the flowing body of water (to level 20 as shown) in a fixed manner. While it is envisioned that the main body of the assembly can be configured in any desirable fashion for receiving the inlet water flow, one desirable application provides for an electrical generator component 21 (generically termed an electrical converting component) supported atop the main support structure 12 in the manner shown in FIG. 2 and so that it is sufficiently located above the surface 20 of the moving water flow. Although not depicted, it is also understood that the electrical generator component 21 can be substituted by any other suitable work output (not shown)

As depicted at 22 in each of FIGS. 1-2, a naturally flowing inlet water source is directed along an inlet passageway or conduit 24 (see as best shown in FIG. 1) for introduction to an outer peripheral location of the cylindrical side wall 14 of the swirl chamber. The grate 19 is positioned at the interface of the inlet water source 22 with the delivery conduit 24 in order to filter out any of debris, other contaminants, and importantly also fish and other marine aquatic life.

The construction of the grate 19, including the selection and sizing of any filtering mesh associate associated therewith, can further be selected based upon the environment within it is place, such considerations also including what types of marine life/contaminants can be expected and how often it is desirable to change or clean the filters. Regardless of the sizing and application of the grating or filtering component, the design of the system is further such that fish and the like can safely pass through the swirl chamber and out the discharge with minimal odds of damaging the components of the assembly and/or injuring or killing the marine life.

A shaft 28 is supported in vertically extending and centrally located fashion within the swirl chamber defining cylindrical side wall 14. As shown in FIG. 2, the shaft 28 is supported at an upper extending end by a journal support bracket 30 affixed to the underside of the upper chamber wall 12. The shaft 28 is supported by bearings 32 and 34 at upwardly extending locations through the interior of the bracket 30, the shaft extending through an aperture (see inner circumferential surface 36) in the top wall 12 and terminating in contact with the electrical generator 21. In this fashion, the rotating output of the shaft 28 is transferred to the generator 21 in order to create an electrical output (such as for powering a nearby residence or other structure having electricity requirements).

One non-limiting example of a plurality of paddles, or vanes, is depicted in FIG. 1 by a plurality of five such vanes 38, 40, 42, 44 and 46 arranged about the shaft 28. As shown in FIG. 1, the vanes 38, 40, 42, 44 and 46 each exhibit an intermediate angled or bent location in order to maximize its fluid initiated rotational driving input delivered to the shaft 28. Without limitation, the configuration of the vanes can be modified from that shown and can also envision other three dimensional or turbine designed components which can have smooth arcuate or other surface profiles configured to maximize the fluid driving forces created within the swirl chamber.

To this end, an initial water inlet location is depicted by arrow 48 in each of FIGS. 1-2 and which is intended to represent the inlet fluid flow through the conduit location 24 for introduction at the outer peripheral location (further at 50 in FIG. 1) associated with the cylindrical swirl chamber interior. A swing arm 49 is integrated into the entry gate of the assembly, this defined by a pivotal screw mount 51 positioned at an inner terminating wall location along an inner surface of the inlet flow passageway 24, and which is opposed by an outer guiding wall 53 which in turn transitions into a circulator outer chamber wall 55 defining the swirl chamber. The swing arm 49, without limitation, can be dimensioned a substantial height of the flow passageway and, through the use of the heavy duty screw actuator, can pivot adjustable (see phantom adjusted positions 49′ and 49″), in order to tune a volume of water flow into the generator in order to optimize operation of the same.

As further shown in FIG. 1, the flow inlet profile is converted to a continual swirl pattern, see further arrows 52, 54 and 56, this being further propagated and maintained by the vertical drop (distance 58 in FIG. 2) associated with the inlet 24 to outlet 60 interface location, this again aligning with the position of the central supported rotating shaft 28.

In one non-limiting example, the vertical drop can be a minimal distance (such as two to three feet corresponding to a four foot diameter swirl chamber construction) with the resulting fluid pattern adopting a descending swirl (or cyclonic) pattern between the (higher) inlet and the (lower) outlet. Without limitation, the water generating assembly is scalable to any dimensions associated with the sizing of the flowing water body within which it is placed and factoring in the desired electrical (or other work) output requirements.

The further advantage of the cyclonic generated flow pattern is in maximizing the rotational driving forces exerted by the fluid upon the vanes 38-46, and by extension the shaft 28, relative to the speed of the fluid flow. This is further assisted by the generation of the internal kinetic energy forces within the swirl chamber which, combined with the weight of the upper level and continually in-flowing water, operates in conjunction with the naturally generated vortex in order to accelerate the speed of the water flow, and thereby enhance and improve shaft speed output, and by extension the ability to generator more output power (e.g. electrical or otherwise).

Also depicted in FIG. 2 is a water aeration chamber (or component) 62 of any known construction and which is mounted proximate a bottom-most extending end 64 of the shaft 28 and at a location proximate the open central underside of the swirl chamber through which a fluid accelerating base of the cyclonic fluid flow is exited from the swirl chamber through the underside outlet 60 as an oxygenated exiting water flow 66.

Advantages of the system include the ability to both magnify and optimize a power output associated with slow to moderate flowing bodies of water, within which the generator is situated, and such as which are often further associated with relatively small vertical drops in elevation associated with the body of water (e.g. rivers, streams, etc.). The construction of the water powered electrical generator is again further such that it is largely safe to marine aquatic life and can further include a water outflow oxygenator for further benefitting such marine life including notably fish.

The system is further designed to return the water flow directly back into the river or other flowing body of water of origin. The oxygenation component 62, being driven by the extending underside of the rotation shaft 28 to which it is secured, further assists in increasing the overall oxygenation content of the water, this in turn improving the quality of the river. Also, and given that the system is placed into a flowing body of water with modest vertical drop (i.e. often no more than a couple of feet at the location identified at outlet 60), minimal or no head pressure is created at the outlet (the existence of higher pressures otherwise resulting in the death of many smaller fish caught in the system).

Having described my invention, other and additional preferred embodiments will be apparent to those skilled in the art to which it pertains, and without deviating from the scope of the appended claims.

I claim:

1. A water powered generator, comprising:
a cylindrical shaped body supported in a substantially submerged fashion within a flowing body of water;
a rotatable shaft extending vertically through a central interior of said body and about which are secured a plurality of vanes;
an inlet of said body directing an inlet flow of fluid into an outer peripheral location of the body interior; and
a vertically descended outlet of said body aligning with the central interior and causing the creation of a vortex in the fluid passing within the body, enhancing the rotational driving of the shaft, and prior to the fluid being discharged through said outlet.

2. The generator as described in claim 1, further comprising an electrical converting component situated atop said body and communicating with an upper projecting end of said rotating shaft.

3. The generator as described in claim 1, further comprising a bottom end of said shaft supporting a rotary actuated water aeration component.

4. The generator as described in claim 1, further comprising a debris gate situated at said inlet.

5. The generator as described in claim 2, further comprising a journal support bracket affixed to an underside of an upper chamber defining wall associated with said body, said shaft extending upwardly through said bracket and being supported by bearings contained within said bracket, said shaft progressively extending through an aperture in said upper wall and terminating in contact with said electrical converting component.

6. The generator as described in claim 1, further comprising a bracket extending from said body and adapted to affix the same to an underwater bed location.

7. The generator as described in claim 1, further comprising a swing arm pivotally adjustably supported at said body inlet for tuning a volume of water flow into said cylindrical shaped body.

8. The generator as described in claim 7, further comprising said swing arm being integrated into an entry gate of said inlet, this defined by a pivotal screw mount positioned at an inner terminating wall location along an inner surface of an inlet flow passageway, and which is opposed by an outer guiding wall which in turn transitions into an outer wall of said cylindrical shaped body.

9. A water powered generator, comprising:
a cylindrical shaped body exhibited by an outer circular wall, said body supported in a substantially submerged fashion within a flowing body of water;
a rotatable shaft extending vertically through a central interior of said body and about which are secured a plurality of vanes;
an inlet of said body including a linear passageway with an inner extending and terminating wall and an outer opposing wall which transitions into said outer circular wall, said inlet directing a flow of fluid into an outer peripheral location of the body interior;
a vertically descended outlet of said body aligning with the central interior and causing the creation of a vortex in the fluid passing within the body, enhancing the rotational driving of the shaft, and prior to the fluid being discharged through said outlet; and
an work output connected to said shaft and including an electrical converting component.

10. The generator as described in claim 9, further comprising a bottom end of said shaft supporting a rotary actuated water aeration component.

11. The generator as described in claim 9, further comprising a debris gate situated at said inlet.

12. The generator as described in claim 9, further comprising a journal support bracket affixed to an underside of an upper chamber defining wall associated with said body, said shaft extending upwardly through said bracket and being supported by bearings contained within said bracket, said shaft progressively extending through an aperture in said upper wall and terminating in contact with said electrical converting component.

13. The generator as described in claim 9, further comprising a bracket extending from said body and adapted to affix the same to an underwater bed location.

14. The generator as described in claim 9, further comprising a swing arm pivotally adjustably supported at said body inlet for tuning a volume of water flow into said cylindrical shaped body.

15. The generator as described in claim 14, further comprising said swing arm being integrated into an entry gate of said inlet, this defined by a pivotal screw mount positioned at an inner terminating wall location along an inner surface of an inlet flow passageway, and which is opposed by an outer guiding wall which in turn transitions into an outer wall of said cylindrical shaped body.

16. A water powered work output assembly, comprising:
a cylindrical shaped body exhibited by an outer circular wall, said body supported in a substantially submerged fashion within a flowing body of water;
a bracket extending from said body and adapted to affix the same to an underwater bed location;
a rotatable shaft supported in vertically extending through a central interior of said body and about which are secured a plurality of vanes;
a bottom end of said shaft supporting a rotary actuated water aeration component;
an inlet of said body including a linear passageway with an inner extending and terminating wall and an outer opposing wall which transitions into said outer circular wall, said inlet directing a flow of fluid into an outer peripheral location of the body interior;
a swing arm pivotally adjustably supported at said body inlet for tuning a volume of water flow into said cylindrical shaped body;
a vertically descended outlet of said body aligning with the central interior and causing the creation of a vortex in the fluid passing within the body, enhancing the rotational driving of the shaft, and prior to the fluid being discharged through said outlet; and
an work output connected to said shaft and including any of an electrical converting component or a rotary mechanical work output component.

17. The generator as described in claim 16, further comprising a debris gate situated at said inlet.

18. The generator as described in claim 16, further comprising a journal support bracket affixed to an underside of an upper chamber defining wall associated with said body, said shaft extending upwardly through said bracket and being supported by bearings contained within said bracket, said shaft progressively extending through an aperture in said upper wall and terminating in contact with said electrical converting component.

19. The generator as described in claim 16, further comprising said swing arm being integrated into an entry gate of said inlet, this defined by a pivotal screw mount positioned at an inner terminating wall location along an inner surface of an inlet flow passageway, and which is opposed by an outer guiding wall which in turn transitions into an outer wall of said cylindrical shaped body.
